(19) United States
(12) Patent Application Publication
(10) Pub. No.: US 2026/0169121 A1
(43) Pub. Date: Jun. 18, 2026

(54) Detection Network Based On Long Range Sensors Utilizing Vibration Or Acoustic Signals

(71) Applicant: Google LLC, Mountain View, CA (US)

(72) Inventor: Dongeek Shin, San Jose, CA (US)

(21) Appl. No.: 18/710,982

(22) PCT Filed: Mar. 15, 2023
(86) PCT No.: PCT/US2023/015285

§ 371 Date: May 16, 2024

(51) Int. Cl. G01S 5/30; G01C 21/36; G08G 1/14

(52) U.S. Cl. CPC G01S 5/30; G01C 21/3685; G08G 1/14

(57) ABSTRACT

This technology generally relates to a system configured to determine the location of a vehicle using a network of long-range sensors utilizing vibrational or acoustic signals. The system may estimate the location of a vehicle using at least two of the long-range sensors, based on the intersection of the distances between the vehicle and each of the long-range sensors. Such a location can be used to identify how many vehicles are within the area being tracked and where each of those vehicles are located. The system may further be configured to generate a parking availability map based on the estimated location of the vehicles. Additionally, the long-range sensors may use vibrational or acoustic signals to determine the distance between each long-range sensor to generate a map of the finite area of the parking facility.

### BACKGROUND

Existing parking management systems can detect the availability of parking spaces on a space-by-space basis by positioning a sensor within each parking space. Each sensor may be connected to a central system, such that it can detect when a vehicle enters or leaves the parking space. Some parking management systems can also include multiple cameras or additional sensors to detect movement through the parking lot, such as in pathways in addition to the spaces. The hardware installation and maintenance of such existing systems is expensive and time consuming, particularly for larger parking lots with numerous spaces.

### BRIEF SUMMARY

The present disclosure provides a system configured to determine the location of a vehicle using a network of long-range sensors utilizing vibrational or acoustic signals. Specifically, the system may estimate the location of a vehicle using multiple long-range sensors strategically positioned around the parking lot, such that the number of sensors is fewer than the number of parking spaces. The system may estimate the location of a vehicle based on the intersection of the distances between the vehicle and each of the long-range sensors. The system may further be configured to generate a parking availability map based on the estimated location of the vehicles.

In part the disclosure relates to a detection system configured to detect the presence of a vehicle within a finite area, the detection system comprising a plurality of long-range sensors, wherein the long-range sensors are configured to detect vibration or acoustic signals, one or more processors in communication with the plurality of the long-range sensors. The one or more processors configured to detect respective distances between a vehicle and each of the plurality of long-range sensors, determine a location of the vehicle and generate a parking availability map of the finite area. The parking availability map may be in image or video format.

According to aspects of the disclosure, the long-range sensors may be capable of ultrawide band communication, and the long-range sensors may use ultrawide band communication to determine the location of the plurality of long-range sensors. According to aspects of the disclosure, in determining the locations of the long-range sensors using the one or more processors may be further configured to transmit one or more signals across a wide spectrum frequency to each of the plurality of long-range sensors, receive a response from each of the plurality of long-range sensors, and compute, for each response received, based on a time of the transmitting and a time of receiving, the location of the long-range sensor. Further, the plurality of the long-range sensors may be configured to map the boundaries of the finite area by detecting the distances between each of the plurality of long-range sensors.

According to aspects of the disclosure, the one or more processors may be configured to determine physical coordinates of the vehicle based on the detected distances from each of the plurality of the long-range sensors. In generating the parking availability map, the physical coordinates based on the vibrational or acoustic data may be translated into image or video format. The determined location of the vehicle may be a relative location with respect to the plurality of long-range sensors.

According to aspects of the disclosure, the system may be further configured to receive inputs from a driver device and output the parking availability map to the driver device.

According to aspects of the disclosure, in determining the location of the vehicle, the one or more processors may be configured to determine a point at which relative distances between the vehicle and each of the plurality of long-range sensors intersect. Further, in determining the location of the vehicle, the one or more processors may be configured to compute a maximum likelihood of estimation based on the locations of each long-range sensor.

In part, the disclosure relates to a method comprising detecting, using a plurality of long-range sensors, a plurality of distances between a vehicle and each of the plurality long-range sensors, determining, with one or more processors based on the detected distances, a location of the vehicle, and generating, based on the detected distances, a parking availability map of the finite area. The parking availability map may be in image or video format.

According to aspects of the disclosure, the long-range sensors may be capable of ultrawide band communication, and the long-range sensors may use ultrawide band communication to determine the location of the plurality of long range-sensors. Further, the plurality of the long-range sensors may be configured to map the boundaries of the finite area by detecting the distances between each of the plurality of long-range sensors.

According to aspects of the disclosure, the one or more processors may be configured to determine physical coordinates of the vehicle based on the detected distances from each of the plurality of long-range sensors. In generating the parking availability map, the physical coordinates of the vehicle, based on the vibrational or acoustic signals, may be translated into image or video data. The determined location of the vehicle may be a relative location with respect to the plurality of the long-range sensors.

According to aspects of the disclosure, the method may further comprise receiving inputs from a driver device and outputting the parking availability map to the driver device.

In part, the disclosure relates to a computer readable medium storing instructions executable by one or more processors for performing a method of localization of a vehicle, the method comprising detecting, using a plurality of long-range sensors, a plurality of distances between a vehicle and each of the plurality of long-range sensors, determining, with one or more processors based on the detected distances, a location of the vehicle, and generating, based on the detected distances, a parking availability map of the finite area.

### BRIEF DESCRIPTION OF THE DRAWINGS

FIG. 1 is a pictorial diagram illustrating an example system according to aspects of the disclosure.

FIG. 2A-B are functional diagrams of example systems in accordance with aspects of the disclosure.

FIG. 3 is a pictorial diagram illustrating an example system according to aspects of the disclosure.

FIG. 4 is a pictorial diagram illustrating an example self-mapping feature of the system according to aspects of the disclosure.

FIG. 5 is a pictorial diagram illustrating an example vehicle location feature of the system according to aspects of the disclosure.

FIG. 6 is a pictorial diagram illustrating example vehicle location techniques according to aspects of the disclosure.

FIG. 7 is a flow diagram illustrating an example method according to aspects of the disclosure.

### DETAILED DESCRIPTION

The present disclosure provides a mechanism to synchronously drive distributed long-range sensors positioned within or around the boundaries of a parking lot to detect a vehicle based on vibrational or acoustic signals from the vehicle. The system may estimate the location of a vehicle using a plurality of the long-range sensors, based on the intersection of the distances between the vehicle and each of the long-range sensors. Such a location can be used to identify how many vehicles are within the area being tracked and where each of those vehicles are located. The system may further be configured to generate a parking availability map based on the estimated location of the vehicles.

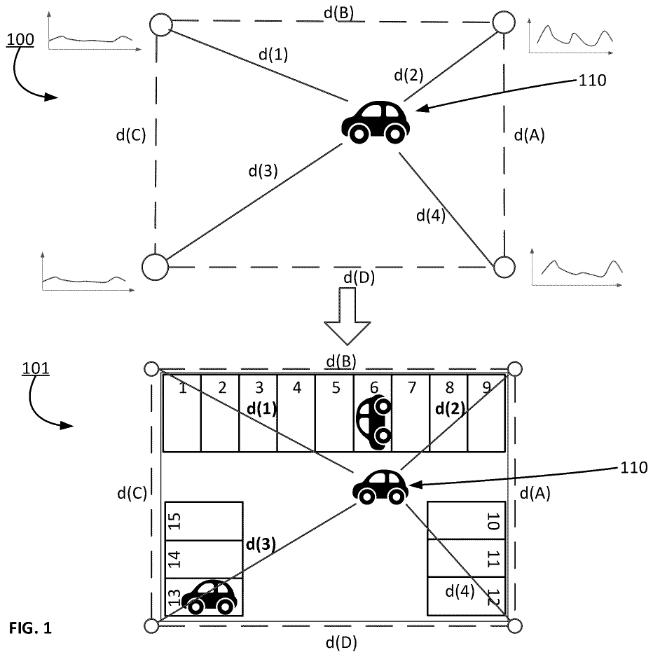

FIG. 1 illustrates a system 100 including a plurality of long-range sensors adapted to detect a presence of vehicles using acoustic or vibrational signals which may be used to generate parking availability map 101. The sensors may be separated by respective distances d(A), d(B), d(C), and d(D), which may be manually entered into a computing system or automatically discovered by the sensors. The relative distances between the plurality of sensors may be correlated with map information, such that as vehicles are detected by the sensors the positions of the vehicles may also be represented on the map 101.

The plurality of sensors may detect vehicle 110, such as by detecting vibrations, acoustics, and or other signals caused by the presence and movement of the vehicle 110. The sensors may measure vibrational and/or acoustic signals, depicted by the line graphs beside each sensor, to detect vehicle 110. The system 100 may estimate the location of vehicle 110 based on distances d(1), d(2), d(3), and d(4) and the vibrational and/or acoustic signals.

Data regarding the positioning of vehicle 110 may be integrated onto the map 101. For example, the position of the vehicle 110 may be correlated with geographic positions on the map. The map may further include markings, such as roadways, curbs, parking spaces, crosswalks, etc. In some examples, system 100 may integrate information regarding multiple vehicles onto the map to mark which parking spaces are available.

### I. System Description

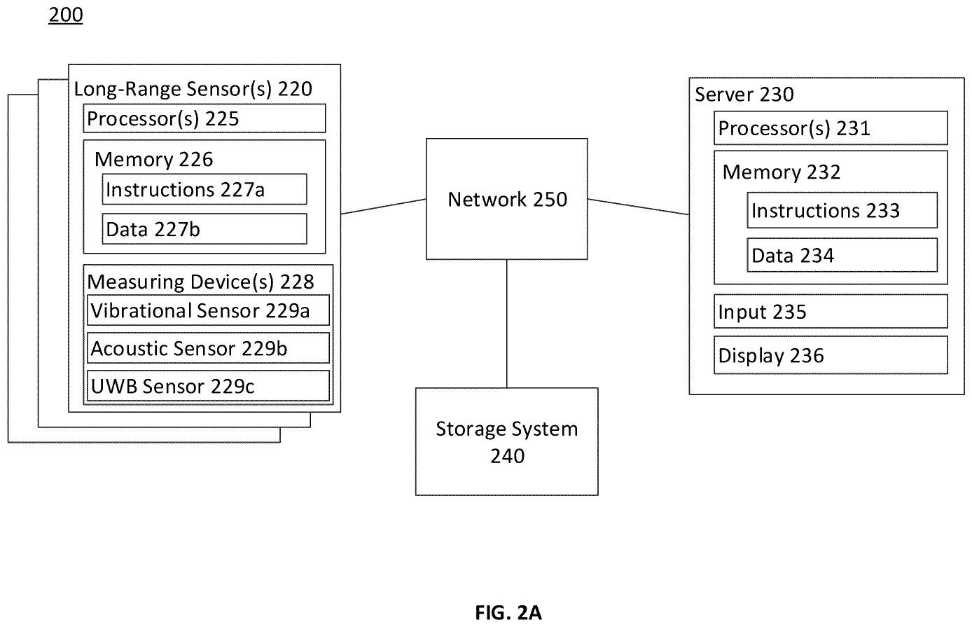

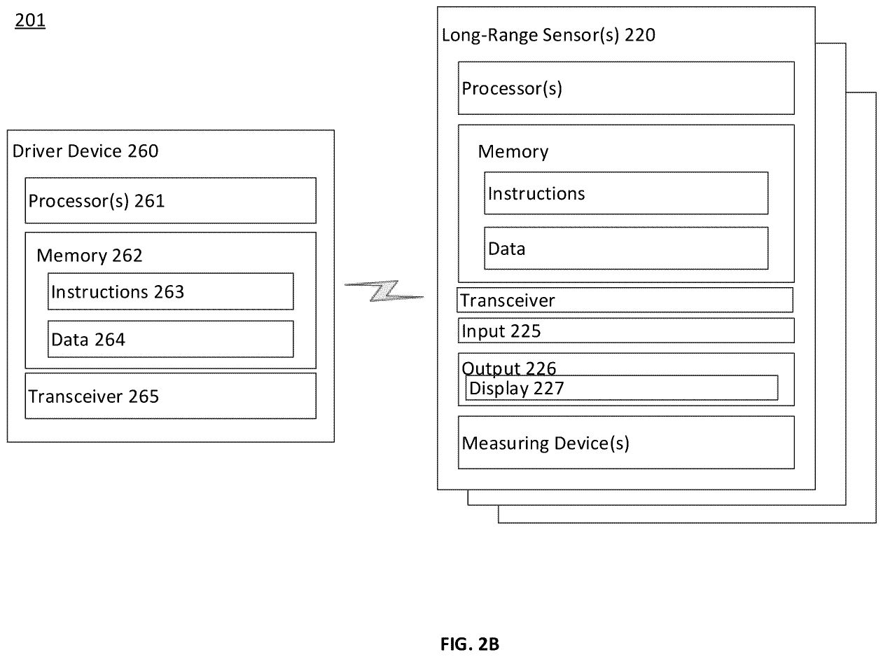

FIG. 2A illustrates an example system 200 in which the features described herein may be implemented. It should not be considered limiting the scope of the disclosure or usefulness of the features described herein. In this example, system 200 includes long-range sensors 220, a central server 230, a storage system 240, and network 250.

As shown, the long-range sensor 220 includes various components, such as one or more processors 225 and other components typically present in microprocessors, general purpose computers, or the like. Sensor 220 also includes measurement device(s) 228 such as IMU sensors, vibration sensor, UWB sensors, etc.

The one or more processors 225 may be any conventional processors, such as commercially available microprocessors. Alternatively, the one or more processors may be a dedicated device such as an application specific integrated circuit (ASIC) or other hardware-based processor. Although FIG. 2A functionally illustrates the processor, memory, and other elements of sensor 220 as being within the same block, it will be understood by those of ordinary skill in the art that the processor, computing device, or memory may include multiple processors, computing devices, or memories that may or may not be stored within the same physical housing. Similarly, the memory may be a hard drive or other storage media located in a housing different from that of sensor 220. Accordingly, references to a processor or computing device will be understood to include references to a collection of processors or computing devices or memories that may or may not operate in parallel.

Memory 226 may store information that is accessible by the processors 225, including instructions 227a that may be executed by the processors 225, and data 227b. The memory 227a may be of a type of memory operative to store information accessible by the processors 225, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. The subject matter disclosed herein may include different combinations of the foregoing, whereby different portions of the instructions 106 and data 108 are stored on different types of media.

Data 227b may be retrieved, stored or modified by processors 225 in accordance with the instructions 227a. For instance, although the present disclosure is not limited by a particular data structure, the data 227b may be stored in computer registers, in a relational database as a table having a plurality of different fields and records, XML documents, or flat files. The data 227b may also be formatted in a computer-readable format such as, but not limited to, binary values, ASCII or Unicode. Moreover, the data 227b may comprise information sufficient to identify the relevant information, such as numbers, descriptive text, proprietary codes, pointers, references to data stored in other memories (including other network locations) or information that is used by a function to calculate the relevant data.

The instructions 227a can be any set of instructions to be executed directly, such as machine code, or indirectly, such as scripts, by the processor 225. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods, and routines of the instructions are explained in more detail below.

Sensor 220 may further include measurement device(s) 228. The measurement device(s) 228 may include other types of sensors, such as vibrational sensor 229a for detecting vibrational signals or acoustic sensor 229b for acoustic signals from the vehicle. The vibrational sensor 229a may include sensors capable of receiving vibrational signals, such as microphones, a vibrometer, a velocity meter, an accelerometer, a phase meter, or a frequency meter, etc. The acoustic sensor 229b may include a thickness-shear mode resonator, surface acoustic wave (SAW) sensor, shear-horizontal acoustic plate mode (SH APM) sensor, flexural plate wave (FPW) sensor, and inertial measurement unit (IMU) sensors, such as an accelerometer, gyroscope, etc. For example, gyroscopes may detect the inertial positions of the vehicle, while accelerometers detect linear movements of the vehicle. Such sensors may detect direction, speed, and/or other parameters of the movements. The sensors may additionally or alternatively include any other type of sensors capable of detecting changes in received data, where such changes may be correlated with user movements. For example, the sensors may include a barometer, motion sensor, temperature sensor, a magnetometer, a pedometer, a global positioning system (GPS), proximity sensor, strain gauge, camera, etc. The one or more sensors of each device may operate independently or in concert.

The measurement device(s) 228 may include further one or more UWB sensor(s) 229c. The UWB sensor 229c or other proximity sensor may be used to determine a relative position, such as angle and/or distance, between two or more sensors. Such information may be used to detect a relative position of other long-range sensors, and therefore detect a relative position of the vehicle with respect to the sensors.

As shown, the central server 230 includes various components, such as one or more processors 231 and other components typically present in microprocessors, general purpose computers, or the like. Server also includes a memory 232, input 235, and display 236. The server may be used to process information received from the long-range sensors 220. The server may be used to communication information to a user, such as an owner of a parking lot.

The server 230 may further include an input 235. The input 235 may be, for example, a touch sensor, dial, button, or other control for receiving a manual command. The input 235 may, in some examples, be a microphone.

Server 230 may include display 226. Display 236 and other displays described herein may be any type of display, such as a monitor having a screen, a touch-screen, a projector, or a television. The display 236 of server 230 may electronically display information to a user via a graphical user interface (“GUI”) or other types of user interfaces. For example, as will be discussed below, display 236 may electronically display a map interface with turn-by-turn directions between two or more geographic locations, corresponding road segments, and waypoints to maximize the overall probability of finding an open parking location when searching in a predefined area surrounding the final geographic location.

It should be understood that the server 230 may include other components which are not shown, such as a battery, charging input for the battery, signal processing components, etc. Such components may also be utilized in execution of the instructions 233.

Although FIG. 2A functionally illustrates the processor, memory, and other elements of server 230 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of server 230. Accordingly, references to a processor or computing device will be understood to include references to a collection of processors or computing devices or memories that may or may not operate in parallel.

The server 230 may be located at a node of network 250 and capable of directly and indirectly communicating with other nodes of network 250. The network 250 and intervening nodes described herein can be interconnected using various protocols and systems, such that the network can be part of the Internet, World Wide Web, intranets, wide area networks, or local networks. The network can utilize standard communications protocols and systems, such as Ethernet, Wi-Fi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

As an example, each server 230 may include one or more servers capable of communicating with storage system 240 as well as sensor 220 via the network 250. For example, one or more of long-range sensors 220 may use network 250 to transmit and present information to a user on a display of server 230. In this regard, server 230 may be considered client interface and may perform all or some of the features described above and herein.

In some examples, the server 230 may communicate with a driver device, such as to provide the driver with output indicating availability of parking spaces as detected by the long-range sensors 220. The driver device may be any device capable of outputting information regarding the given area monitored by the long-range sensors 220. For example, the driver device may be a mobile phone, smartphone, a wireless-enabled PDA, a tablet PC, a wearable computing device (e.g., a smartwatch, AR/VR headset, earbuds), laptops, hubs, gaming consoles, an in-vehicle navigation system, or any device that is capable of obtaining information via the Internet or other networks, etc.

Storage system 240 may store data related to parking availability for retrieval in response to a parking reservation request. In some examples, storage system 140 may include a database. The database may store information, images, and/or metadata that may be provided by an application, such as a search service provider or a mapping application, in response to a search query or request.

FIG. 2B further illustrates example computing devices in system 201, and features and components thereof. System 201 may be configured wherein the long-range sensors 220 are capable of collecting data, storing data, and processing data within each sensor. For example, the long-range sensor may receive UWB signals from another long-range sensor and determine the location of the other long-range sensor within its own processing unit.

While the example illustrates one driver device in communication with a plurality of long-range sensors, additional driver devices may be included. According to other examples, processing may be performed by different processors in the different devices in parallel, and combined at one or more devices.

The driver device 260 includes various components, such as a processor 261, memory 262 including instructions 263 and data 264, transceivers 265, and other components typically present in a mobile phone, smartphone, a wireless-enabled PDA, a tablet PC, a wearable computing device (e.g., a smartwatch, AR/VR headset, earbuds), laptops, hubs, gaming consoles, home assistant devices, an in-vehicle navigation system.

The driver device 260 may also be equipped with short range wireless pairing technology, such as a Bluetooth transceiver, allowing for wireless coupling with other devices. For example, transceiver 265 may include an antenna, transmitter, and receiver that allows for wireless coupling with another device. The wireless coupling may be established using any of a variety of techniques, such as Bluetooth, Bluetooth low energy (BLE), UWB, etc.

Long-range sensors 220 may be capable of directly receiving information via input 225 from a user. The input 225 may include, for example, one or more touch sensitive inputs, a microphone, sensors, etc. For example, a user may input how many long-range sensors are within the system or the relative locations of each sensor. Long-range sensors 220 may be capable of directly receiving information via input 225 from a driver, from the driver device 260. This driver input may be used by the sensor 220 to update the parking availability of the given area. For example, the driver device 260 may allow the driver to mark a specific spot within the given area being monitored by the system 200 as where their vehicle is currently parked. The designation would be received by the long-range sensor 220. Long-range sensor 220 may use the designation to update the parking availability of the given area. Moreover, the input 225 may include an interface for receiving data from the other long-range sensors.

Long-range sensor 220 may output information to a user via output 226 using the display 227. For example, the long-range sensor may provide information to a user regarding the number of vehicles currently parked within the given area monitored by the sensors. Long-range sensors may communicate to a driver via output 226 and provide information using the driver device 260.

In another example configuration, the server 230 may communicate with the driver device, such as by communicating over the network 250. The server may communicate information to a driver of a vehicle via the driver device.

### A. Building Map

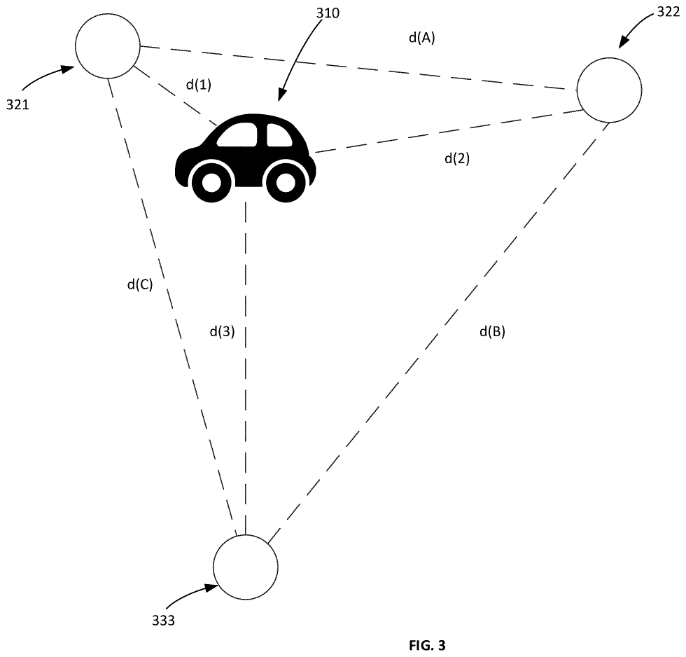

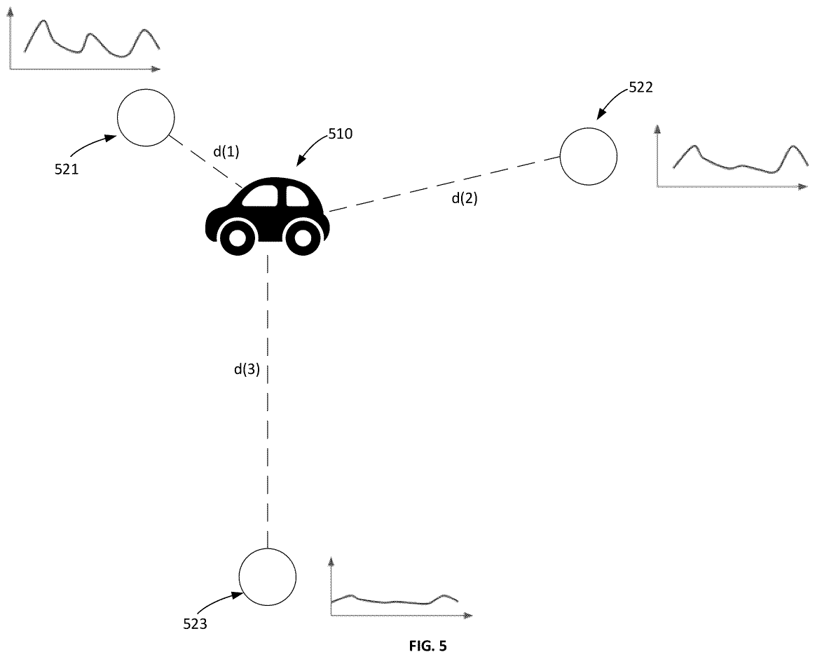

FIG. 3 illustrates an example system including long range sensors 321, 322, and 323 within communication range of each other. At least one of the long-range sensors may determine respective sensor distances d(A), d(B), d(C) between each of the plurality of the long-range sensors 321, 322, and 323. At least one vehicle 310 may be in between at least two of the long-range sensors. The respective distances d(A), d(B), d(C), when considered together may be used to determine an accurate location of the vehicle 310, as described in further connection with FIG. 5. The location of the vehicle may be expressed as a relative location with regard to the long-range sensors 321, 322, and 323. At least one of the long range sensors may determine the respective vehicle distances d(1), d(2), and d(3) between the vehicle 310 and long range sensors 321, 322, and 323. Based on the distances d(1), d(2), and d(3) and the positions of the sensors 321, 322, 323, a location of the vehicle 310 may be determined.

### 1. Detecting Sensor Locations

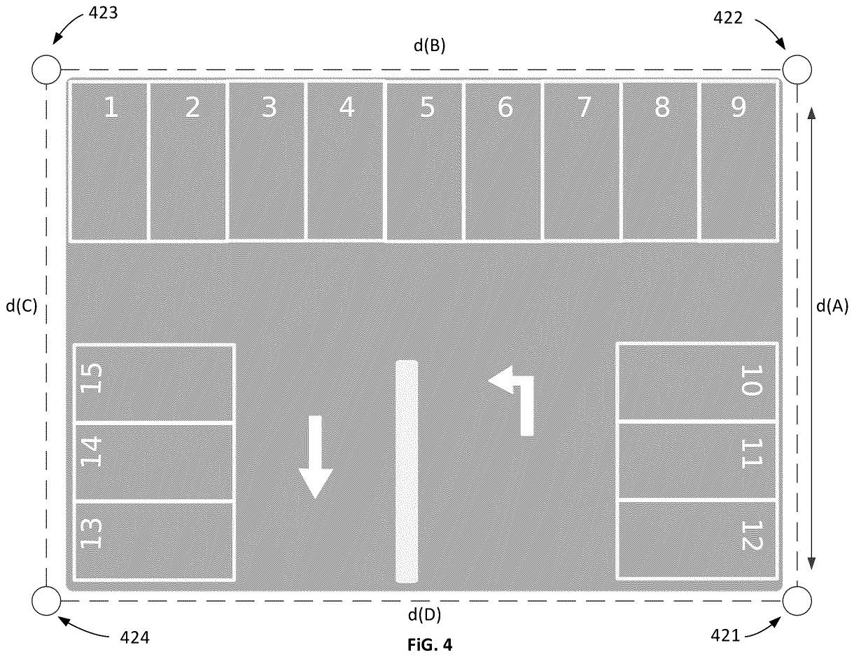

FIG. 4 illustrates a system including long range sensors 411, 412, 413, and 414. Distances d(A), d(B), d(C), and d(D) may extend between pairs of long-range sensors. The sensors may be used to map the space and topology of a given area. The given area may be any area selected by the user to monitor specific movement or occupancy within. In some examples, the given area may be a parking lot, a parking garage, any parking structure, etc.

The long-range sensors may be installed on the ground of a given area. The given area may be a parking lot or parking structure. The long-range sensors may be placed around the perimeter of the area or within the area. The long-range sensors are spaced apart from one another, with two or more sensors per area. The distance between the sensors may vary depending on the size of the area. The distance between each sensor may range from 1 meter to up to 75 or more meters apart. The number of sensors present in the parking lot is dependent on the area of the given area to be monitored.

In some examples, the long-range sensors may be installed on rigid structures within a given area, such that they may still sense vibrational and acoustic signals. The rigid structures may be any structure that is resistant to flexing and moves with the ground surface, such as poles or curbs.

a. Supervised Installation

According to some aspects of the disclosure, the system may determine the locations of the long-range sensors based on a user's input. The user may place the long-range sensors around the given area and mark where the long-range sensors are located. The system may determine the distance between the long-range sensors based on the user's input relating to the long-range sensors' marked locations.

b. Unsupervised Installation

According to other aspects of the disclosure, the system may automatically determine the locations of the long-range sensors based on distances between each sensor detected by the sensors. The long-range sensors may self-determine their relative location through communications amongst the long-range sensors. The long-range sensors may transmit that information to the central server and its processors, and the processors may be further configured to determine the locations of the long-range sensors with respect to the other long-range sensors. In some examples, the long-range sensors may contain processors configured to structure the locations of the long-range sensors with respect to the other long-range sensors. This self-determination may be carried out using any of a variety of suitable communication signals such as UWB, Bluetooth, vibrational, acoustic, sonar, etc.

The long-range sensors 421, 422, 423, and 424 may each store data indicating a relative sensor topology. The relative topology can be learned by each long-range sensor 421, 422, 423, and 424. For example, a first device, such as a long-range sensor 421, may be set up as an origin point (0, 0) and locations of the other long-range sensors 422, 423 and 424 may be established relative to the origin point. For example, the first long-range sensor 421 may send particular signals to a second long-range sensor 422 and receive responses that can be used to determine the distance between the long-range sensors 421 and 422. The first long-range sensor 421 may iteratively use similar techniques to determine the distances between the third long-range sensor 423 and the fourth long-range sensor 424.

In some examples, each long-range sensor may be equipped with UWB capabilities. Each long-range sensor may use UWB to detect its location relative to the other long-range sensors. Specifically, the system may use localization outputs of UWB channels that exist within the long-range sensors to detect the distances of other long-range sensors within the system and vehicles between the sensors. By using robust maximum likelihood estimation (MLE) based on inference, from pairwise distances that the UWB channels measure, the location of the vehicle can be determined with a few centimeters accuracy.

As illustrated in FIG. 4, the system may automatically determine the location of the long-range sensors using a UWB localization process. In the UWB localization process, the first long-range sensor 421 may signal to second long-range sensor 422. Second long-range sensor 422 may prepare a fixed reply in a fixed time and send a reply impulse signal to first long-range sensor 421. The signals may be timestamped when they leave the originating sensor and when it is received by the receiving sensor. First long-range sensor 421 may determine the distance between sensor 421 and 422 using the following equation:

$$d = \frac{c \times ( R T T - {T}_{r e p l y} )}{2}$$

where c is the speed of light, RTT is round trip time of signals back and forth between sensors 421 and 422, and T_{reply} is the time for second long-range sensor 422 to generate the reply signal.

The network of long-range sensors may perform, via one or more processors, relative topology estimates from a list of pairwise range values, formed into a matrix, such as a Euclidean distance matrix (EDM). This can be done by performing multi-dimensional scaling (MDS) techniques on the EDM obtained by the UWB network. The processors may receive the EDM structures of the distances determined by the UWB network of sensors. The relative topology of the given area may be generated by MDS. Specifically, the processors may run an algorithm to compute the geometric centering matrix, using equation:

$$C = I - \frac{1}{n} 1 {1}^{T} ,$$

wherein the C is the Centering matrix, I is the eigenvalue decomposition, n is the number of sensors, and T is matrix transpose. Next, the processors may calculate a Gram matrix, using equation: G=−0.5 C (EDM(T)×C), wherein G is the Gram matrix, calculated Cis the centering matrix, and EDM(T) is the UWB Euclidian distance matrix. The processors may continue to perform eigenvalue decomposition, using equation U,

$${[ {λ}_{i} ]}_{i = 1}^{n} = E V D ( G ) ,$$

wherein U is eigenvector matrix, n is the number of sensors, I is the eigenvalue decomposition of the calculated Gram matrix. The processors may estimate the UWB topology using equation: T_{UWB}=[diag(λ₁), . . . , \sqrt{λ_{d}})0_{d×(N-d)}]U^{T}, wherein T_{UWB} is the estimated UWB topology, d is the distance between UWB sensors, N is the number of sensors, U is eigenvector matrix, and T is matrix transpose.

The system may iteratively repeat the UWB localization process to determine the distance between each long-range sensor and a map of the given area. For example, sensor 421 may determine sensor 422 is distance d(A) away from sensor 421. Sensor 422 may also determine that sensor 423 is distance d(B) away from sensor 422. Sensor 423 may determine that sensor 424 is distance d(C) away from sensor 423. Sensor 424 may determine that sensor 421 is distance d(D) away from sensor 424.

In instances where measurements are noisy, a common intersection point may not exist. Alternatively, to find the most likely common intersection point given noise, a MLE approach may be used. This assumes that the time-of-flight (ToF) values for signals transmitted between the long-range sensors across a wide frequency spectrum are corrupted with additive Gaussian noise.

$$maximize v {\sum }_{k = 1}^{N} L ( v ; {v}_{k} , c \cdot {t}_{k} / 2 )$$

$$ℒ ( v ; {v}_{k} , c \cdot {t}_{k} / 2 ) = exp \{ {( {‖ v - {v}_{k} ‖}_{2} - c \cdot {t}_{k} / 2 )}^{2} / ( 2 \cdot {σ}^{2} ) \}$$

In this equation, v represents coordinates to be determined of a sensor, vₖ represents coordinates of a given sensor k, c is the speed of light, and tₖ is an estimated time between sending a UWB signal from the sensor x to the given sensor k and receiving a response at the vehicle from the given sensor k. Variable k is an index indicating a number of sensors and variable x represents one of the plurality of long-range sensors. For example, k=1, 2, 3, . . . . N to indicate a number of sensors up to N sensors. σ is a tunable parameter that describes noise levels of time delay observations. For example, σ can be an inverse of received signal strength indication (RSSI) values associated with the UWB measurements.

c. Building the Map

Based on each sensors' detected location, the system can determine the boundaries of the given area and the capacity of the given area, etc. In some examples, the capacity of the given area may refer to the number of vehicles may be parked in the given area at one time, such as how many parking spaces are available within the parking lot. The system may use this information to build a dynamic map of the given area. Further, the system may use this map to better locate a vehicle within the given area and build a parking availability map, described in more detail below. In some examples, the given area may be a parking lot and the capacity may relate to the amount of parking spaces within the parking lot or amount of available parking spaces.

In some examples, distances d(A), d(B), d(C) and d(D) and locations of long-range sensors 421, 422, 423, and 424 may be sent to processors, wherein the processors may determine the finite space that makes up the given area, such that the system may create a map of the given area. For example, the processors may determine the boundaries of the given area using the locations of the long-range sensors and the size of a given are using the distances between the long-range sensors.

In some examples, the user may input physical characteristics of the given area to create a more accurate map of the given area. For example, the user may input physical barriers within the given area that would prevent parking or vehicles freely moving through, such as walls or curbs. In other examples, the user may input specific directionality of the given area. For example, the user may input certain entry and exit points of the given area, identify which lanes only accommodate one way traffic, etc.

The system may register spaces within the given area as designated spots. For example, where the given area is a parking lot, the system may designate sections of the area as parking spots, such as the parking spots labelled 1-15 depicted in FIG. 4. In some examples, a user may manually register these parking spaces into the system onto the map of the given space. In some examples, the system may automatically determine these parking spaces. For example, an image capture device may receive images of the geographic are and perform object recognition to detect lines or other markings designating parking spaces. Such detected objects may be correlated with map information to identify locations of the parking spaces on the map. According to other examples, other automation techniques may be used, such as by receiving information from other sources, such as city maps, parking lot management systems, etc.

The information used to create the map may be used to create a display in image or video format, such as animated video of the given area. The system may use one or more machine translation model architectures to translate the raw UWB data into image data. The data-to-image conversion is done but first computing the node coordinates, and assigning the respective data streams on the pixel value representation of the node coordinates. The architecture may be a convolutional neural network that includes a pooling layer, a convolution layer, and a fully connected layer in which the convolution layer is used to convolute the raw data into image data.

According to some examples, the distance detection and location determination may be periodically or continuously updated to account for changes in the locations of the long-range sensors. In some examples, the distance detection and location determination may be updated when the system updates and/or the long-range sensors are moved. This allows for the long-range sensors to run at full power and to devote most of that power to obtaining more accurate sensory readings.

### C. Vehicle Detection Model

The long-range sensors may calibrate a vehicle detection module of the system based on the distances between each sensor. The calibration step may perform example location estimations based on the information from the map, such as the marked parking spots. For example, the calibration step may include determining approximate signals that would be received at each sensor if a theoretical vehicle were parked in each parking space. The estimated signals may be matched with the signals received by the sensors in real time to determine the location of the vehicle. The system may use raw vibrational and/or acoustic data from the sensors or vehicles tracked by the sensors to generate image data. The long-range sensors may calibrate a vehicle detection model of the system based on the distances between each sensor.

FIG. 5 illustrates a simplified example of determining the location of a vehicle based on vibrational or acoustic signals. The system may include at least one vehicle 510 and a plurality of long-range sensors 521, 522, and 523. The system may be configured to determine the location of a vehicle using vibrational and/or acoustic readings from pairing between the vehicle 510 and each of a plurality of long-range sensors 521, 522, and 523. The system may include a vehicle 510 to anchor the system.

According to aspects of the disclosure, the long-range sensors may detect a vehicle entering into the given area and determine the location of the vehicle. The long-range sensors 521, 522, and 523 may detect signals within extreme far fields, such as within a range of 50 meters from each long-range sensor. The long-range sensors may be, for example, geophone low-frequency IMU, etc. The sensors may receive vibrational pulses as a vehicle drives within the range of the sensor. The long-range sensors may additionally or alternatively include acoustic detectors such as microphones, etc. The intensity of the vibrational or acoustic pulses will vary depending on the distance of the vehicle from the sensor.

Each sensor may detect vibrational and/or acoustic signals from vehicle 510 as it moves through the mapped given area. The vehicle will produce stronger signals or more prominent signals to closer sensors. For example, as the vehicle drives away from sensor 522 and towards sensor 521, the signals received by sensor 521 will become stronger and the signals received by sensor 522 will get weaker. If the vehicle 510 is moving parallel to sensor 323 the signals may only incrementally change.

Each vehicle-long range sensor pair can produce a measurement, using vibrational and/or acoustic signals, the measurement indicating the distance between the two devices defining the pair. For N pairs of devices, with the vehicle 510 being the anchor, N distances can be produced. For example, distances d(1), d(2), and d(3) relate to the relative distances between vehicle 510 and sensors 521, 522, and 523, respectively. The distances may change as the vehicle moves through the mapped given area. The line graphs depicted in close proximity to sensors 521, 522, and 523 illustrate the changes in signals as the vehicle 510 moves through the mapped given area.

In some examples, the system may use the determined distances between the sensors and the vehicle to determine an estimated location of the vehicle. The system may estimate the location of the vehicle based on the most probable intersection point of the distances. For example, where the sensor has determined the locations of sensors 521, 522, and 523, the system may estimate the location of the vehicle based on the most probable intersection of d(1), d(2), and d(3). This information may be further supplemented by data from the map. For example, the system may determine that a probable intersection point of the distances may not be where a physical barrier, such as a wall or a curb, is present.

The system may employ a recovery algorithm to solve an optimization problem that maximizes the likelihood function over the coordinate parameters given the pairwise distance data. Once an estimated localization result for the vehicle is determined, the result may be broadcast back to the plurality of sensors and/or the server to perform their respective calibration. According to some examples, such broadcasting can be done over local networks, such as Bluetooth low energy (BLE), and IP-based mesh network, Wi-Fi, etc.

In instances where measurements are noisy, a common intersection point may not exist or be simply determined. Alternatively, to find the most likely common intersection point, the system may use a MLE approach, similar to that described above with respect to the unsupervised installation of the long-range sensors.

The sensors may determine the distance between the sensor and the vehicle using UWB. The sensors may be equipped with measurement device(s), such as IMU sensors, vibration sensors, and/or UWB sensors. The vibration sensors or IMU sensors may detect vibration and/or acoustic signals consistent with the movement of a vehicle, which may trigger the UWB sensor to measure the vehicle's distance or movement. The sensor may send a reply impulse the vehicle and note how long it takes for this signal to bounce off of the vehicle. The sensor will then determine the distance between the sensor and the vehicle using the following equation:

$$d = \frac{c \times ( R T T - {T}_{r e p l y} )}{2}$$

where c is the speed of light.

In some examples where multiple vehicles are present in the designated area, the system may simultaneously detect the location of multiple vehicles. The system may determine the location of multiple vehicles by copying the process of the vehicle location module for multiple vehicles. The above referenced computations may be done in parallel and thus the system can track multiple vehicles at once.

### 1. Updating Map Based on Vehicle Detection Model

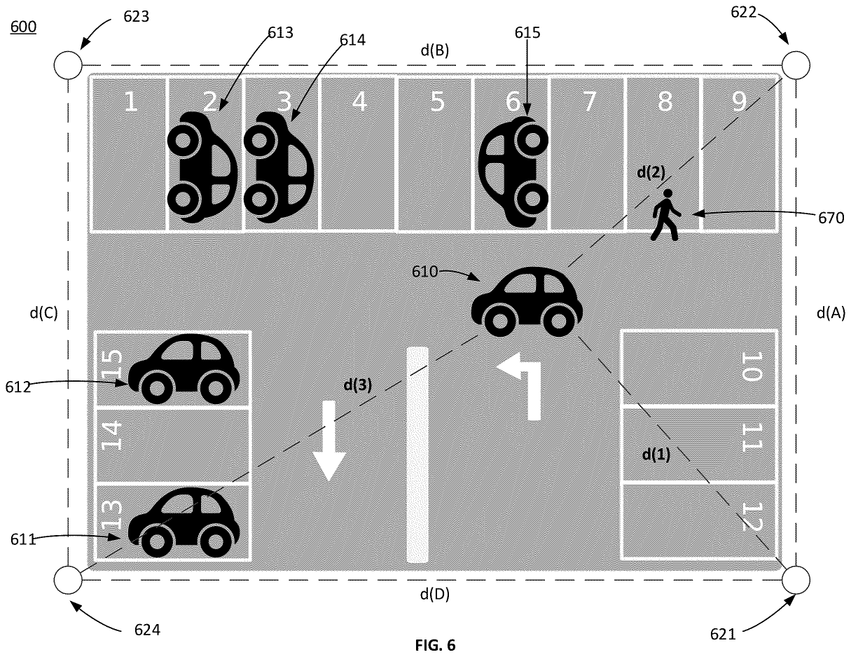

FIG. 6 illustrates a parking availability map 600 updated by the vehicle detection model. The system may include long range sensors 621, 622, 623, and 624. The long-range sensors may have distances d(A), d(B), d(C), and d(D) between them. The system may keep track of multiple vehicles at the same time, such as vehicle 611, 612, 613, 614, and 615.

According to the disclosure, each sensor-vehicle pair can produce a measurement wherein each measurement indicates the distance between each long-range sensor and the vehicle, defining each pair. For N pairs of long-range sensors, with the vehicle being the anchor, N distance measurements can be produced. For example, if four long-range sensors are located within a given area, the vehicle will form four pairs with the sensors, wherein the vehicle is the anchor of each pair. The four sensor-vehicle pairs will produce four distance measurements. The distance measurements may be different from each other and may change as the vehicle moves within the given area.

The long-range sensors may encounter interference from the environment unrelated to the vehicles they are intended to track. Sources of interference may be vehicles outside of the given area, pedestrians, bicyclists, conditions due to weather, etc. The long-range sensors may be equipped with an additional layer of intelligence to remove interference with the sensor's measurements. The additional layer of intelligence may be, for example, a sound parser. The additional layer may remove interference on the front end before the interference is recorded. For example, the pedestrian 470 may interfere with the vibrational and/or signals between vehicle 410 and sensor 422. Sensor 422 utilizes the additional layer of intelligence to determine the vibrational and/or acoustic data to determine the signals are not coming from a vehicle but from a pedestrian.

Directionality of the vehicle may also be tracked by the sensors. For example, the system may ascertain the direction the vehicle is travelling based on the movement of the vehicle as determined by the sensors. The system may use this information to alert a user as to whether the vehicle is heading towards an open or occupied area, such that the user may decide whether the parking spots are being effectively used.

The system may track when the vehicle 610 has stopped moving within the given area. In some examples, the system may determine through the sensors that the vehicle has not moved in a set amount of time. For example, the system may be set up such that after a given amount of time, for example 5 minutes, of non-movement of the vehicle, the vehicle has parked. In some examples, the system may determine through the sensors that the vibrations or noises coming from the vehicle have changed, suggesting that the engine has been shut off. For example, the sensors may be tracking a moving vehicle through a given area and detect a change in the vibrational change when the vehicle shuts off. The sensors may communicate signals to either the internal or external processors that the vehicle has parked. In some examples, the system may determine through the sensors that a vehicle has reached a spot designated for parking purpose.

The system may register spaces within the given area as parking spots. A user may manually register these parking spaces into the system onto the map of the given space. The system may automatically determine these parking spaces based on repeated long-term stopping in various areas. For example, the system may determine that a particular portion of a given area frequently hold vehicles for extended periods of time. The system may mark these spots are parking spots. The sensors may determine that a vehicle has reached one of these parking spaces and the system may use this information to determine that a vehicle has parked. The system may receive feedback from the user to inform the parking availability map 600. For example, the user may approve or deny whether the designated spots were correctly labelled as parking spots.

In some examples, driver may access or update the parking availability map 600 via a driver device. For example, the driver device may be used to convey the parking availability map to a driver. The parking availability map 600 depict on the driver device how many parking spots are currently available. The driver device may allow the driver to reserve a specific spot within the given area being monitored by the system for a future time. The reservation would be received by the system. The system may use the reservation to update the parking availability map 600 to reflect the driver's reservation.

### D. Method

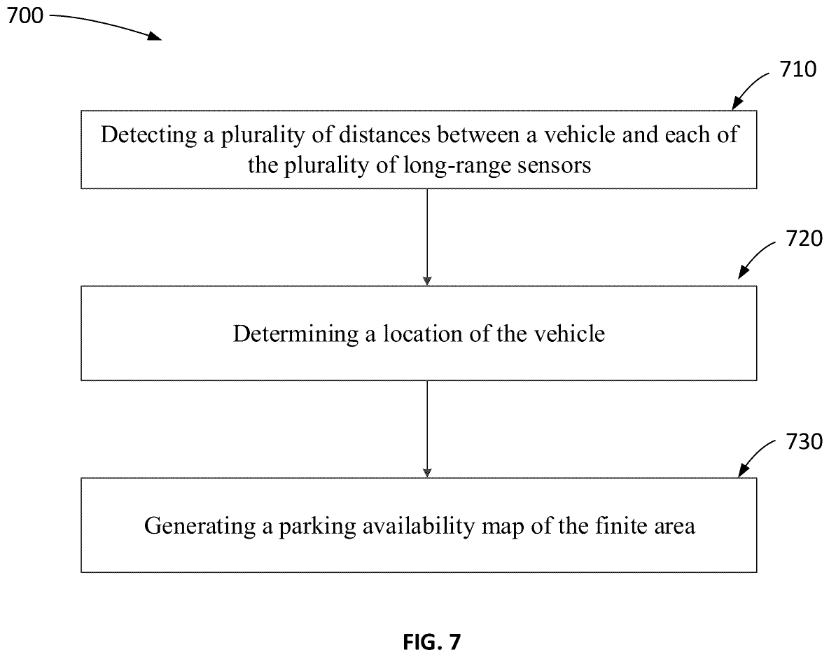

FIG. 7 is a flow diagram illustration an example method 700 of using vibrational and/or acoustic signals to determine vehicle location based on a relative location of the vehicle to a plurality of long range sensors, and outputting an availability map based on the determined location. The method 700 may be performed by the plurality of long-range sensors, one or more of the plurality of sensors, a separate controller device, a device associated with a vehicle, or any combination of such devices. While the operations are illustrated and described in a particular order, it should be understood that the order may be modified and that operations may be added or omitted.

In block 710, distances between the vehicle and each of the long-range sensors are determined based on vibrational and/or acoustic signals. For example, a transmitter in one of the plurality of long range sensors receives one or more vibration and/or acoustic signals from the vehicle as the vehicle moved throughout the parking area. Each long-range sensor within range of the vehicle will receive a vibration and/or acoustic signals.

In block 720, a location of the vehicle is determined based on the detected distances between the vehicle and each long-range sensor. According to one example, the location may be determined by finding an intersection point of a plurality of long-range sensors. The signals from each sensor will be correlated with the map generated from the determined locations of the long-range sensors. Based on the signal data and the map, the system will determine the location of the vehicle within the parking lot.

In block 730, the system may generate a parking availability map of the fixed area, such as parking lot or parking garage. The map may be calibrated based on the determined locations of the long-range sensors.

The location detection may be updated, for example, periodically or continually. Accordingly, as placement of sensors changes, the availability map may be adjusted to accommodate the sensors' updated locations.

The foregoing techniques are advantageous in that they provide for an improved parking management system without costly dedicated devices, cumbersome setup, or the like.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A detection system configured to detect the presence of a vehicle within a finite area, the detection system comprising:
a plurality of long-range sensors, wherein the long-range sensors are configured to detect vibration or acoustic signals;
one or more processors in communication with the plurality of long-range sensors, the one or more processors configured to:
detect, using the plurality of long-range sensors, respective distances between a vehicle and each of the plurality of long-range sensors;
determine, based on the detected distances, a location of the vehicle; and
generate, based on the detected distances, a parking availability map of the finite area.

2. The detection system of claim 1, wherein the parking availability map is in image or video format.

3. The detection system of claim 1, wherein the long-range sensors are capable of ultrawide band communication, and the long-range sensors use ultrawide band communication to determine the location the plurality of long-range sensors.

4. The detection system of claim 3, wherein determining the locations of the plurality of the long-range sensors, the one or more processors are configured to:
transmit one or more signals across a wide spectrum frequency to each of the plurality of long-range sensors;
receive a response from each of the plurality of long-range sensors; and
compute, for each response received, based on a time of the transmitting and a time of receiving, the location of each long-range sensor.

5. The detection system of claim 1, wherein the plurality of long-range sensors is further configured to map the boundaries of the finite area by detecting distances between each of the plurality of long-range sensors.

6. The detection system of claim 1, wherein the one or more processors are further configured to determine physical coordinates of the vehicle based on the detected distances from each of the plurality of long-range sensors.

7. The detection system of claim 6, wherein in generating the parking availability map the physical coordinates of the vehicle, based on the vibrational or acoustic data, are translated into image or video data.

8. The detection system of claim 1, wherein the determined location of the vehicle is a relative location with respect to the plurality of long-range sensors.

9. The detection system of claim 1, wherein the system is further configured to receive inputs from a driver device; and output the parking availability map to the driver device.

10. The detection system of claim 1, wherein in determining the location of the vehicle, the one or more processors are further configured to determine a point at which relative distances between the vehicle and each of the plurality of long-range sensors intersect.

11. The detection system of claim 1, where in determining the location of the vehicle, the one or more processors are configured to compute a maximum likelihood of estimation based on the locations of each long-range sensor.

12. A method, comprising
detecting, using a plurality of long-range sensors, a plurality of distances between a vehicle and each of the plurality of long-range sensors;
determining, with one or more processors based on the detected distances, a location of the vehicle; and
generating, based on the detected distances, a parking availability map of the finite area.

13. The method of claim 12, wherein the parking availability map is in image or video format.

14. The method of claim 12, wherein the long-range sensors are capable of ultrawide band communication, and the long-range sensors use ultrawide band communication to determine the location of long-range sensors.

15. The method of claim 12, wherein the plurality of long-range sensors is further configured to map the boundaries of the finite area by detecting distances between each of the plurality of long-range sensors.

16. The method of claim 12, wherein the one or more processors are further configured to determine physical coordinates of the vehicle based on the detected distances from each of the plurality of long-range sensors.

17. The method of claim 16, wherein in generating the parking availability map the physical coordinates of the vehicle, based on the vibrational or acoustic data, are translated into image or video data.

18. The method of claim 12, wherein the determined location of the vehicle is a relative location with respect to the plurality of long-range sensors.

19. The method of claim 12, further comprising receiving inputs from a driver device; and outputting the parking availability map to the driver device.

20. A computer readable medium storing instructions executable by one or more processors for performing a method of localization of a vehicle, the method comprising:
detecting, using a plurality of long-range sensors, a plurality of distances between a vehicle and each of the plurality of long-range sensors;
determining, with one or more processors based on the detected distances, a location of the vehicle; and
generating, based on the detected distances, a parking availability map of the finite area.
